(19) United States
(12) Patent Application Publication
(10) Pub. No.: US 2014/0306819 A1
(43) Pub. Date: Oct. 16, 2014

(54) SYSTEM AND A METHOD FOR LOCATING AND NOTIFYING FAULT AND HANDLING ALARM THEREOF

(71) Applicant: ABB RESEARCH LTD, Zurich (CH)

(72) Inventors: Sanjay SH GHOSH, Bangalore (IN); Srikanth R, Bangalore (IN); Ivan Bernard Fuller, Chennai (IN)

(21) Appl. No.: 14/314,494

(22) Filed: Jun. 25, 2014

Related U.S. Application Data
(63) Continuation of application No. PCT/IB2012/002745, filed on Dec. 19, 2012.

(30) Foreign Application Priority Data
Dec. 26, 2011 (IN) 4558/CHE/2011

(51) Int. Cl. G08B 29/02

(52) U.S. Cl. CPC G08B 29/02
USPC 340/506

(57) ABSTRACT

A system and method are disclosed for locating and notifying of a fault, and handling an alarm thereof. The system can include at least one field device, a central alarm management component, at least one handheld device and at least one wireless hub. The wireless hub is connected with the at least one field device and/or the at least one handheld device, for analyzing the fault and/or locating the appropriate handheld device correspondingly in relation to the fault.

### RELATED APPLICATION

This application claims priority as a continuation application under 35 U.S.C. §120 to PCT/IB2012/002745, which was filed as an International Application on Dec. 19, 2012 designating the U.S., and which claims priority to Indian Application 4558/CHE/2011 filed in India on Dec. 26, 2011. The entire contents of these applications are hereby incorporated by reference in their entireties.

### FIELD

The present disclosure relates to handling alarms in an industrial control system, and for example to a system and a method for locating and notifying of a fault and of handling an alarm thereof.

### BACKGROUND

In alarm management systems, the alarms that are generated or that require attention or the like, have been filtered based on some predefined set of rules before being notified to an operator on a display. The operator upon being notified of such alarms take appropriate action based on the perceived knowledge in response to those alarms in order to rectify the fault through the operator console or through the site personnel available at the site. This approach, which is in current practice, can have certain drawbacks pertinent to, identifying the appropriate site personnel, availability of the site personnel and the proximity in relation to the device that has been encountered with a fault, locating the site personnel and the device at fault especially when they are non-stationary, communicating the information regarding the fault to the site personnel or operator and so on. In all of the above, delay or time lapse and sharing of information are of concern.

Further, the site personnel many a time involve additional support from the experts located remotely so as to rectify the fault or perform troubleshooting. Also, the site personnel can acknowledge the status of the alarm that has been notified for rectification to the operator, after attending to the same. This can further add to the delay or time lapse in attending to, and addressing the issues in relation to any particular fault and/or of the alarm thereof.

It is evident that known systems are more personnel dependent and ultimately can cause unnecessary delay or time lapse. This dependency may be important at times, which cannot be ignored and compels it be attended to with utmost priority and importance. It can be clearly understood from the above that there is a desire to manage the handling of alarms considering various aspects including, locating the device at fault, identifying appropriate site personnel to attend to the fault, acknowledging the status of the alarm after rectifying the fault etc. It is appreciable to cater to the above by a system having improved alarm handling capability that employs workflow which locates and notifies the fault and handles the alarm in a convenient manner that may be partially or fully automatic.

The present disclosure describes a system and a method that can notify and locate a fault, and handle an alarm including rectification of the fault in a manner that is automatic and more reliable.

### SUMMARY

A system is disclosed for locating and notifying of a fault, and handling an alarm thereof, the system comprising: at least one field device; a central alarm management component; a plurality of handheld devices; and a plurality of interconnected wireless hubs communicatively coupled to the at least one field device and the plurality of handheld devices, wherein at least a wireless hub from the plurality of interconnected wireless hubs is configured to analyze a fault, locate an appropriate handheld device corresponding to the fault based on one or more parameters, and route a fault notification associated with the fault to the appropriate handheld device using the plurality of interconnected wireless hubs.

A method is also disclosed for locating and notifying of a fault, and handling an alarm thereof, by a system having at least one field device; a central alarm management component; a plurality of handheld devices; and a plurality of interconnected wireless hubs communicatively coupled to the at least one field device and the plurality of handheld devices, wherein at least a wireless hub from the plurality of interconnected wireless hubs is configured to analyze a fault, locate an appropriate handheld device corresponding to the fault based on one or more parameters, and route a fault notification associated with the fault to the appropriate handheld device using the plurality of interconnected wireless hubs, the method comprising: sending information in relation to the fault of the field device by the field device to the wireless hub corresponding to the field device; analyzing the information by the wireless hub; identifying an appropriate handheld device to notify of the fault and of the alarm thereof based on one or more parameters, by the wireless hub; notifying of the fault and of the alarm thereof to the appropriate handheld device by the corresponding wireless hub connected thereto with the appropriate handheld device; and updating a status of the fault and of the alarm thereof that had been notified, by the appropriate handheld device and the wireless hub, upon rectifying the fault by the site personnel corresponding with the appropriate handheld device.

### BRIEF DESCRIPTION OF THE DRAWINGS

Exemplary embodiments are disclosed herein with reference to the accompanying drawings in which:

FIG. 1 shows an exemplary system of the present disclosure; and

FIG. 2 depicts an exemplary method of the present disclosure.

### DETAILED DESCRIPTION

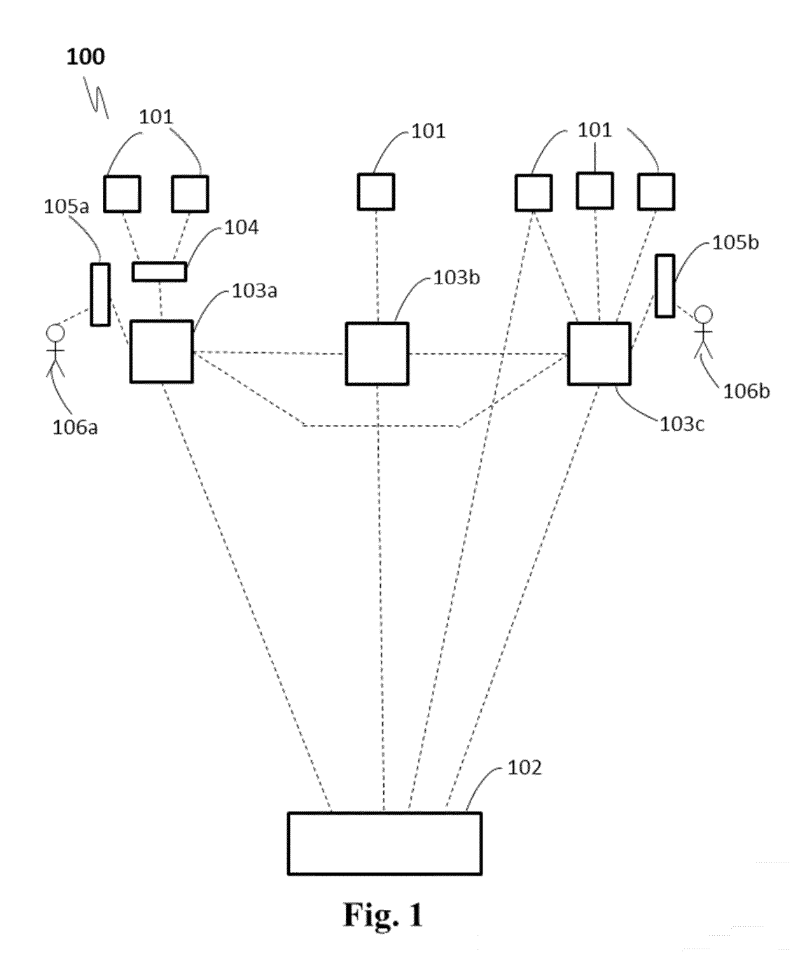

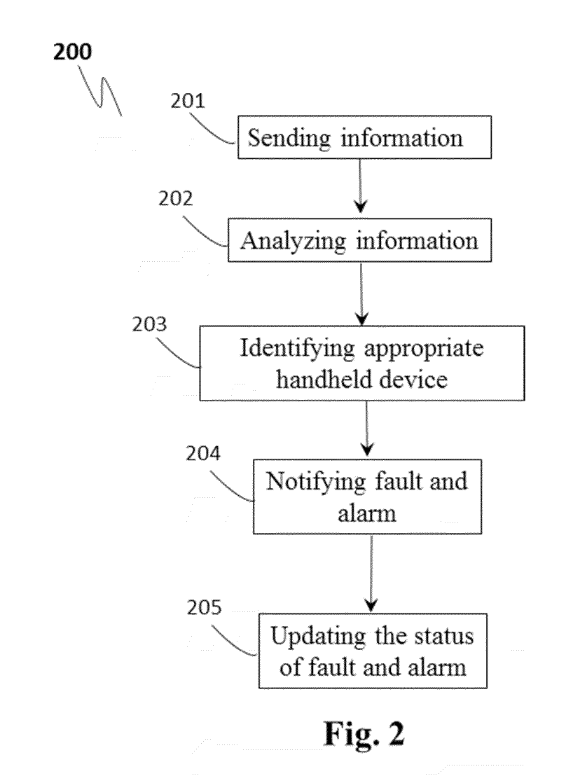

Exemplary embodiments are described herein with reference to non-exhaustive exemplary embodiments as shown in FIGS. 1 and 2.

A system is disclosed that locates and notifies of a fault of a device or the like.

The system can also rectify the fault efficiently, and handle an alarm in a manner that is more reliable than known systems. The system can be partially or fully automatic.

A system as disclosed can have improved performance in relation to locating and notifying of a fault and of handling an alarm thereof, and reducing any delay or time lapse. A method is also disclosed to locate and notify of a fault, and of handling an alarm thereof.

A system is disclosed for locating and notifying of a fault, and handling an alarm thereof. An exemplary system includes at least one field device, a central alarm management component, and at least one handheld device. The system along with the aforesaid can include at least one wireless hub. The wireless hub is connected with the at least one field device and/or the at least one handheld device, for analyzing the fault and/or locating the appropriate handheld device correspondingly in relation to the fault.

A method is also disclosed for locating and notifying of a fault, and handling an alarm thereof, by a system as disclosed herein. The method can include sending information in relation to the fault of the field device by the field device to the central alarm management component and/or wireless hub corresponding to the field device. The method can include analysing the information by the central alarm management component and/or the wireless hub, identifying an appropriate handheld device to notify of the fault and of the alarm thereof, by the central alarm management component or the wireless hub. The method can also include notifying of the fault and of the alarm thereof to the appropriate handheld device by the corresponding wireless hub connected thereto with the appropriate handheld device, and updating the status of the fault and of the alarm thereof that had been notified, by the appropriate handheld device to the central alarm management component and/or the wireless hub, before and/or after rectifying the fault by the site personnel correspondingly associated with the appropriate handheld device.

FIG. 1 shows a system for locating and notifying of a fault, and handling an alarm thereof, in accordance with the present disclosure. The system (100) can include at least one field device (101) such as an equipment, a communication unit, protection device, processing device, control device, relay device or the like, deployed in the field. The field device (100) is connected to a central alarm management component (102) or to at least one wireless hub (103a, 103b, 103c, . . . ). The field device (100) may be connected to one of the wireless hub (103a, 103b, 103c, . . . ) either directly or through a converging device (104), and either alone or along with other field devices, and may also be connected to the central alarm management component (102).

The central alarm management component (102) is configured so as to perform one or more functions such as receiving or obtaining information from the at least one field device (101), at least one wireless hub (103a, 103b, 103c, . . . ), at least one handheld device (105a, 105b, . . . ) etc, processing or analyzing the information or event, raising and/or notifying by an alarm in respect of the fault, and providing suggestions or a solution to rectify the fault.

The system (100) also can include at least one handheld device (105a, 105b, . . . ). Each of the handheld devices (105a, 105b, . . . ) can be correspondingly associated with a site personnel (106a or 106b or . . . ). The handheld devices (105a, 105b, . . . ) are connected accordingly with at least one wireless hub (103a, 103b, 103c, . . . ). Such connection being established with the handheld devices (105a, 105b, . . . ) can be registered with its corresponding at least one wireless hub (103a or 103b or 103c . . . ). The handheld devices (105a, 105b, . . . ) are capable of being registered with other such wireless hubs (103a or 103b or 103c . . . ) than the present corresponding wireless hub (103a or 103b or 103c . . . ) based on the range of the wireless hub (103a or 103b or 103c . . . ) or relative proximity of the handheld device (105a, 105b, . . . ) in relation to the wireless hub (103a or 103b or 103c . . . ). Also, the handheld devices (105a, 105b, . . . ) are configured to include the profile of correspondingly associated site personnel (106a, 106b, . . . ). The profile referred to herein can include the availability status and/or other relevant information pertinent to the site personnel (106a, 106b, . . . ) and of the engagement thereof, history including skills, past performance, history of solution provided, etc. of the site personnel (106a, 106b, . . . ).

The wireless hubs (103a, 103b, 103c, . . . ) are connected to each other selectively or in their entirety. The wireless hubs (103a, 103b, 103c, . . . ) are also connected to the central alarm management component (102). Also, the wireless hub (103a, 103b, 103c, . . . ) is configured to include one or more of information, profile or the like pertaining to at least one field device (101) and of the corresponding at least one handheld device (105a, 105b) and of the corresponding site personnel (106a, 106b) associated thereto. The wireless hubs (103a, 103b, 103c, . . . ) are configured so as to perform additional functions such as receiving or obtaining information from the at least one field device (101), at least one handheld device (105a, 105b, . . . ) etc, processing or analyzing the information or event, raising and/or notifying by an alarm in respect of the fault, providing suggestions or solutions to rectify the fault.

The field devices (101) and the handheld devices (105a, 105b, . . . ) are stationary or non-stationary or any combination thereof. The connection or association referred to herein before in the description in relation to the field devices (101), central alarm management component (102), handheld devices (105a, 105b, . . . ), wireless hubs (103a or 103b or 103c . . . ), site personnel (106a, 106b) accordingly is either wired or wireless or both. The wireless connection is either a short range communication or long range communication or both. Further, the exemplary system (100) can be either a centralized system or a decentralized system.

FIG. 2 depicts an exemplary method for locating and notifying of a fault, and handling an alarm thereof. The exemplary embodiment in relation of the method therein is explained further in conjunction with the system as illustrated in FIG. 1. The method (200) primarily includes: a) sending information (201), b) analyzing information (202), c) identifying appropriate handheld device (203), d) notifying of a fault and an alarm thereof (204) and e) updating the status of the fault and alarm thereof (205).

The step of sending information (201) purports to send the information in respect of the fault of the field device (101) by the field device (101) to the central alarm management component (102) or wireless hub (103a, 103b, 103c, . . . ) corresponding to the field device (101) or both.

The step of analyzing information (202) purports to include processing or filtering the information or both, as compared or as against other such information in relation to the other faults and alarm thereof or the like in respect of other such field devices (101) which had been sent by such other field devices (101) to the wireless hub (103a, 103b, 103c, . . . ) and/or central alarm management component (102).

The step of identifying an appropriate handheld device (203) from the handheld devices (105a, 105b, . . . ) to notify the fault and of the alarm thereof by the central alarm management component (102) or the wireless hub (103a, 103b, 103c, . . . ) includes optimally identifying the appropriate handheld device. Such identification is based on certain fixed and/or flexible parameters. The fixed parameters include one or more parameters such as emergency of the fault, priority of the alarm etc. Accordingly, the flexile parameters include one or more of the parameters such as proximity of the site personnel and of the associated handheld device, availability of the site personnel, work distribution amongst the site personnel, profile of the site personnel, other faults or alarms related to the said fault or said alarm, etc. The terms fixed and flexible referred herein above are associated with rigidity or criticality or weightage or the like.

The step of notifying of a fault and alarm thereof (204) includes notifying of fault and of the alarm thereof to the appropriate handheld device by the corresponding wireless hub (103a, 103b, 103c, . . . ) connected thereto with the appropriate handheld device or through such other wireless hub (103a, 103b, 103c, . . . ) connected to the corresponding wireless hub (103a, 103b, 103c, . . . ). The step of notifying of the fault and of the alarm thereof include providing relevant and at least minimum information relating to the fault and of the alarm thereof that is sufficient to rectify the fault and the alarm thereof.

The step of updating the status of the fault and alarm thereof (205) pertains to updating the status of the fault and of the alarm thereof before and/or after the same has been rectified. Such updating is performed by the handheld device (105a, 105b, . . . ) in relation to the wireless hub (103a, 103b, 103c, . . . ) and/or the central alarm management component (102).

The step of updating also includes requesting further information by the appropriate handheld device to the wireless hub (103a, 103b, 103c, . . . ) or said central alarm management component (102). Such request can be made through the wireless hub (103a, 103b, 103c, . . . ) connected thereto with the appropriate handheld device or through at least one of such other wireless hub (103a, 103b, 103c, . . . ) connected with the wireless hub (103a, 103b, 103c, . . . ) or directly to the central alarm management component (102).

Accordingly, the step of updating can also include providing information or above said further information relating to the fault and of the alarm thereof by the wireless hub (103a, 103b, 103c, . . . ) or central alarm management component (102) to the appropriate handheld device. This can be provided through the wireless hub (103a, 103b, 103c, . . . ) connected thereto with the appropriate handheld device or through at least one of such other wireless hubs (103a, 103b, 103c, . . . ) connected with the wireless hub (103a, 103b, 103c, . . . ) or directly from the central alarm management component (102).

The information pertaining to the fault and of the alarm thereof and in respect of notifying and of updating the status as described herein above can be in whole or part.

The method disclosed herein can also include rectifying the fault and addressing the alarm thereof accordingly by the site personnel in association with the appropriate handheld device identified for that purpose.

The method can also provide for rejecting the notification in respect of a fault and of the alarm thereof either wholly or partially through or by the appropriate handheld device configured accordingly. Further the method caters to returning or assigning the notification of fault and of the alarm thereof along with relevant information in relation thereto by the appropriate handheld device or wireless hub (103a, 103b, 103c, . . . ) or central alarm management component (102) to at least one other site personnel associated with at least one such other appropriate handheld device.

The method (200) described here before can be either fully or partially automatic catering to the need as slated before.

The system and method disclosed herein can either alone or jointly be applied in a Distributed Control System (DCS), Substation Automation System, Supervisory Control and Data Acquisition (SCADA), Power Generation System, Power Systems, Railways, Water distribution system, Gas distribution system, etc.

Features of the invention have been specifically illustrated and described herein, and many modifications and changes will occur to those skilled in the art. The invention is not restricted by the preferred embodiments described herein in the description. It is to be noted that the invention is explained by way of exemplary embodiments and is neither exhaustive nor limiting. Certain aspects of the invention that have not been elaborated herein in the description are well understood by those skilled in the art. Also, the terms relating to singular form used herein in the description also include its plurality and vice versa, wherever applicable. Any relevant modifications or variations, which are not described specifically in the specification are in fact to be construed of being within the scope of the invention. The appended claims are intended to cover all such modifications and changes which fall within the spirit of the invention.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A system for locating and notifying of a fault, and handling an alarm thereof, the system comprising:
at least one field device;
a central alarm management component;
a plurality of handheld devices; and
a plurality of interconnected wireless hubs communicatively coupled to the at least one field device and the plurality of handheld devices, wherein at least a wireless hub from the plurality of interconnected wireless hubs is configured to analyze a fault, locate an appropriate handheld device corresponding to the fault based on one or more parameters, and route a fault notification associated with the fault to the appropriate handheld device using the plurality of interconnected wireless hubs.

2. The system as claimed in claim 1, comprising:
at least one converging device to which the at least one field device is connected.

3. The system as claimed in claim 1, wherein the central alarm management component is configured to perform at least one of:
a. obtaining information from the at least one field device, at least one wireless hub from the plurality of interconnected wireless hubs, and at least one handheld device from the plurality of handheld devices;
b. analyzing the fault;
c. notifying by an alarm in respect of the fault; and
d. providing a solution to rectify the fault.

4. The system as claimed in claim 1, wherein a handheld device from the plurality of handheld devices is registered to at least one wireless hub among the plurality of interconnected wireless hubs, and is configured to be registered with an other wireless hub based on a relative proximity of the handheld device in relation to the one wireless hub and the other wireless hub.

5. The system as claimed in claim 1, wherein a handheld device from the plurality of handheld devices is configured to include a profile of a site personnel associated therewith.

6. The system as claimed in claim 5, wherein the profile includes an availability status and information pertinent to the site personnel and of an engagement history including skills, past performance, and history of a solution provided of the site personnel.

7. The system as claimed in 6, wherein a wireless hub from the plurality of interconnected wireless hubs is configured to include one or more of information or profile pertaining to said at least one field device and of a corresponding handheld device and of a corresponding site personnel associated thereto.

8. A method for locating and notifying of a fault, and handling an alarm thereof, by a system having at least one field device; a central alarm management component; a plurality of handheld devices; and a plurality of interconnected wireless hubs communicatively coupled to the at least one field device and the plurality of handheld devices, wherein at least a wireless hub from the plurality of interconnected wireless hubs is configured to analyze a fault, locate an appropriate handheld device corresponding to the fault based on one or more parameters, and route a fault notification associated with the fault to the appropriate handheld device using the plurality of interconnected wireless hubs, the method comprising:
sending information in relation to the fault of the field device by the field device to the wireless hub corresponding to the field device;
analyzing the information by the wireless hub;
identifying an appropriate handheld device to notify of the fault and of the alarm thereof based on one or more parameters, by the wireless hub;
notifying of the fault and of the alarm thereof to the appropriate handheld device by the corresponding wireless hub connected thereto with the appropriate handheld device; and
updating a status of the fault and of the alarm thereof that had been notified, by the appropriate handheld device and the wireless hub, upon rectifying the fault by the site personnel corresponding with the appropriate handheld device.

9. The method as claimed in claim 8, wherein the parameters are one or more fixed parameters which include an emergency of the fault, or priority of the alarm.

10. The method as claimed in claim 8, wherein the parameters are one or more flexible parameters which include proximity of the site personnel and of the associated handheld device, availability of the site personnel, work distribution amongst the site personnel, profile of the site personnel, or other faults or alarms related to the fault or said alarm.

11. The method as claimed in claim 8, wherein notifying of the fault and of the alarm thereof comprise:
performing the notifying by at least the wireless hub through at least one other wireless hub.

12. The method as claimed in claim 8, wherein updating the status comprises:
requesting further information by the appropriate handheld device to the wireless hub through one or more wireless hubs of the plurality of interconnected wireless hubs.

13. The method as claimed in claim 8, comprising:
providing information relating to the fault and of the alarm thereof by the wireless hub to the appropriate handheld device.

14. The method as claimed in claim 10, wherein the parameters are one or more flexible parameters which include proximity of the site personnel and of the associated handheld device, availability of the site personnel, work distribution amongst the site personnel, profile of the site personnel, or other faults or alarms related to the fault or said alarm.

15. The method as claimed in claim 14, wherein notifying of the fault and of the alarm thereof comprise:
performing the notifying by at least the wireless hub through at least one other wireless hub.

16. The method as claimed in claim 15, wherein updating the status comprises:
requesting further information by the appropriate handheld device to the wireless hub through one or more wireless hubs of the plurality of interconnected wireless hubs.

17. The method as claimed in claim 16, comprising:
providing information relating to the fault and of the alarm thereof by the wireless hub to the appropriate handheld device.

18. The system as claimed in claim 2, wherein the central alarm management component is configured to perform at least one of:
a. obtaining information from the at least one field device, at least one wireless hub from the plurality of interconnected wireless hubs, and at least one handheld device from the plurality of handheld devices;
b. analyzing the fault;
c. notifying by an alarm in respect of the fault; and
d. providing a solution to rectify the fault.

19. The system as claimed in claim 18, wherein a handheld device from the plurality of handheld devices is registered to at least one wireless hub among the plurality of interconnected wireless hubs, and is configured to be registered with an other wireless hub based on a relative proximity of the handheld device in relation to the one wireless hub and the other wireless hub.

20. The system as claimed in claim 19, wherein a handheld device from the plurality of handheld devices is configured to include a profile of a site personnel associated therewith.
